(19) United States
(12) Patent Application Publication
(10) Pub. No.: US 2008/0056726 A1
(43) Pub. Date: Mar. 6, 2008

(54) Dispersion compensation apparatus and dispersion compensation method

(75) Inventors: Hideaki Sugiya, Kawasaki (JP); Satoru Okano, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/878,222

(22) Filed: Jul. 23, 2007

(30) Foreign Application Priority Data
Aug. 29, 2006 (JP) 2006-232134

(51) Int. Cl. H04B 10/02

(52) U.S. Cl. 398/147

(57) ABSTRACT

A dispersion compensation apparatus includes a dispersion compensation unit that conducts dispersion compensation on an optical signal sent from a transmitting device through a transmission path. The dispersion compensation unit includes a switch that switches a path of the optical signal between a first path and a second path, and that latches to one of the first path and the second path to which the path is switched; and a fixed dispersion compensation unit that is provided on the second path, and that conducts dispersion compensation at a fixed level upon an optical signal passing through the second path.

### CROSS-REFERENCE TO RELATED APPLICATIONS

This application is based upon and claims the benefit of priority from the prior Japanese Patent Application No. 2006-232134, filed on Aug. 29, 2006, the entire contents of which are incorporated herein by reference.

### BACKGROUND OF THE INVENTION

1. Field of the Invention

The present invention relates to dispersion compensation and optical fibers in communication systems.

2. Description of the Related Art

During transmission over optical fiber transmission channels, wavelength dispersion occurs along the optical fiber and because of this deterioration of the transmitted signal, dispersion compensation is required. In particular, for high speed signals, such as optical carrier 192 (10 gigabits per second (Gbps)), wavelength dispersion tolerance decreases thereby requiring the degree of dispersion compensation to be finely set.

Commonly, when compensation is conducted collectively over a large bandwidth (e.g., wavelength division multiplexing transmission), a method is employed that utilizes an optical fiber for the transmission channel that is a dispersion compensation fiber (DCF) having an opposite wavelength dispersion.

The degree of dispersion compensation of a DCF depends on the length thereof and hence, the level of dispersion compensation is fixed. As such, in order to compensate for various degrees of dispersion, a method is employed involving the use of a switch to switch between DCFs having different fixed compensation levels. Japanese Patent Application Laid-Open Publication No. H7-327012 is an example of application of this method. Another method employed to compensate for various degrees of wavelength dispersion employs a dispersion compensator that can conduct various levels of dispersion compensation.

A problem exists with the method involving a switch to switch between multiple DCFs. For example in the event of a power failure and power supply is disrupted, the status of the switch changes and dispersion compensation by stabilized levels of dispersion compensation can no longer be conducted.

Further, since the level of dispersion compensation of each DCF is fixed, in order to set fine degrees of dispersion compensation, a large quantity of DCFs are required. In addition, the insertion of the switch causes large signal loss.

As for the dispersion compensator that can conduct various levels of dispersion compensation, although fine degrees of dispersion compensation can be set, dispersion compensation levels beyond the variable range of the dispersion compensator can not be set.

### SUMMARY OF THE INVENTION

It is an object of the present invention to at least solve the above problems in the conventional technologies.

A dispersion compensation apparatus according to one aspect of the present invention includes a dispersion compensation unit that conducts dispersion compensation on an optical signal sent from a transmitting device through a transmission path. The dispersion compensation unit includes a switch that switches a path of the optical signal between a first path and a second path, and that latches to one of the first path and the second path to which the path is switched; and a fixed dispersion compensation unit that is provided on the second path, and that conducts dispersion compensation at a fixed level upon an optical signal passing through the second path.

A dispersion compensation method according to another aspect of the present invention is of conducting dispersion compensation on an optical signal sent from a transmitting device through a transmission path. The dispersion compensation method includes switching, based on a desired compensation level, a path of the optical signal between a first path and a second path for the optical signal; latching to one of the first path and the second path to which the path is switched; and conducting dispersion compensation at a fixed level on an optical signal passing through the second path when the path is switched to the second path at the switching.

The other objects, features, and advantages of the present invention are specifically set forth in or will become apparent from the following detailed description of the invention when read in conjunction with the accompanying drawings.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a dispersion compensation apparatus according to a first embodiment of the present invention;

FIG. 2 is a block diagram of a dispersion compensation apparatus according to a second embodiment of the present invention;

FIG. 3 is a block diagram of a dispersion compensation apparatus according to a third embodiment of the present invention;

FIG. 4 is a block diagram of a dispersion compensation apparatus according to a fourth embodiment of the present invention;

FIG. 5A illustrates an example of switch settings for a −200 ps/nm wavelength dispersion occurring in an SMF transmission path;

FIG. 5B illustrates an example of switch settings for a −600 ps/nm wavelength dispersion occurring in an SMF transmission path;

FIG. 5C illustrates an example of switch settings for a −900 ps/nm wavelength dispersion occurring in an SMF transmission path;

FIG. 5D illustrates an example of switch settings for a −1200 ps/nm wavelength dispersion occurring in an SMF transmission path;

FIG. 5E illustrates an example of switch settings for a −1500 ps/nm wavelength dispersion occurring in an SMF transmission path;

FIG. 5F illustrates an example of switch settings for a −2000 ps/nm wavelength dispersion occurring in an SMF transmission path;

FIG. 6A illustrates an example of switch settings for a −200 ps/nm wavelength dispersion occurring in a TW-RS transmission path;

FIG. 6B illustrates an example of switch settings for a −400 ps/nm wavelength dispersion occurring in a TW-RS transmission path;

FIG. 6C illustrates an example of switch settings for a −500 ps/nm wavelength dispersion occurring in a TW-RS transmission path;

FIG. 6D illustrates an example of switch settings for a −600 ps/nm wavelength dispersion occurring in a TW-RS transmission path;

FIG. 6E illustrates an example of switch settings for a −700 ps/nm wavelength dispersion occurring in a TW-RS transmission path;

FIG. 7A illustrates an example of switch settings for a −200 ps/nm wavelength dispersion occurring in an ELEAF transmission path;

FIG. 7B illustrates an example of switch settings for a −300 ps/nm wavelength dispersion occurring in an ELEAF transmission path;

FIG. 8 is a block diagram of an application example for a dispersion compensation apparatus according embodiments of the present invention applied in a communication system;

FIG. 9 is a block diagram of an application example for a dispersion compensation apparatus according to embodiments of the present invention applied in a communication system; and

FIG. 10 is a block diagram of a 3×3 switch application example.

### DETAILED DESCRIPTION OF THE PREFERRED EMBODIMENTS

Exemplary embodiments according to the present invention will be explained in detail below with reference to the accompanying drawings.

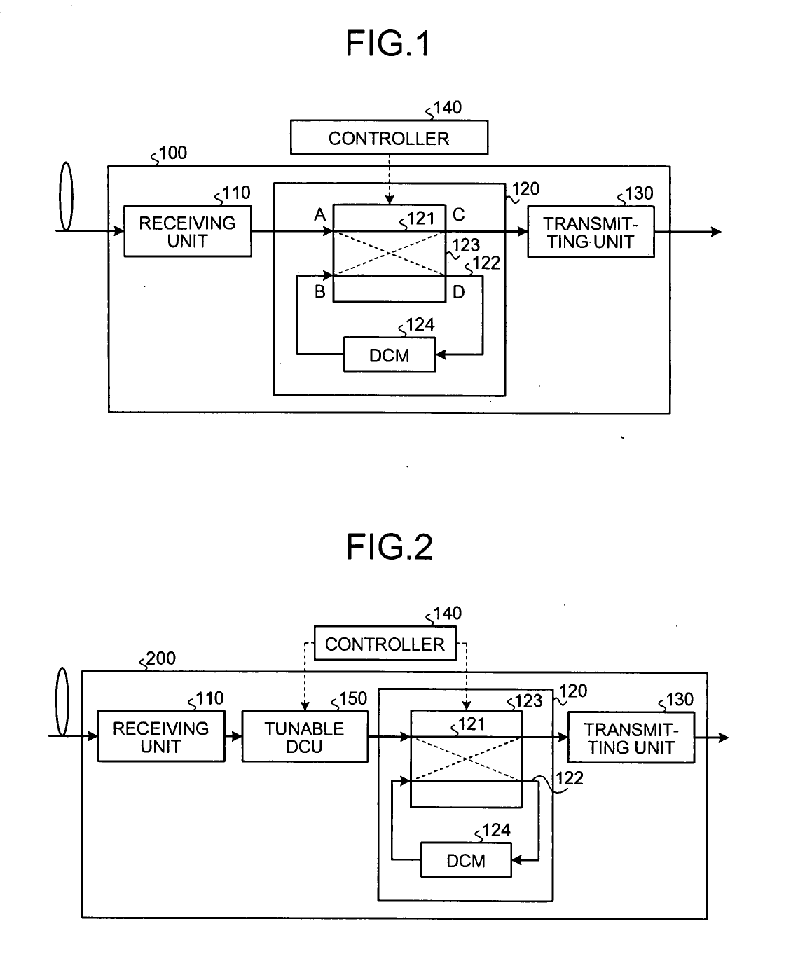

FIG. 1 is a block diagram of a dispersion compensation apparatus according to a first embodiment of the present invention. As illustrated in FIG. 1, a dispersion compensation apparatus 100 includes a receiving unit 110, a dispersion compensation unit (DCU) 120 and a transmitting unit 130.

The receiving unit 110 receives an optical signal sent by a transmitter (not shown in the figure) through a transmission path and sends the optical signal to the DCU 120.

The DCU 120 conducts a certain level of compensation on the optical signal. The DCU 120 includes a first path 121, a second path 122, a switch 123, and a dispersion compensation module (DCM) 124.

The first path 121 and the second path 122 pass the optical signal from the receiving unit 110 to the transmitting unit 130. The switch 123, under, for example, control of an external controller 140, switches the path of the optical signal between the first path 121 and the second path 122. Furthermore, the switch 123 has a directional switch latch that enables the controller selected path to be maintained even in the event of a power supply failure.

The switch 123 has, for example, the structure of a crossbar switch as illustrated in FIG. 1. In this case, by switching between bar and cross bar conditions of the switch 123, the path of the signal is switched between the first path 121 and the second path 122. The switch 123 has a first receiver A, a second receiver B, a first transmitter C, and a second transmitter D.

The first path 121 begins from the first receiver A of the switch 123 and goes directly to the first transmitter C without passing the second transmitter D or the second receiver B. The second path 122 begins from the first receiver A of the switch 123, passes through the second transmitter D and the second receiver B, and goes to the first transmitter C.

In other words, if the switch 123 is in the bar condition, the optical signal is guided to the first path 121. If the switch 123 is in the cross condition, the optical signal is guided to the second path 122.

The DCM 124 is provided along the second path 122 and conducts dispersion compensation at a fixed level to the signal passing through the second path 122. The DCM 124, for example, can be constructed of a DCF that has an opposite wavelength dispersion and with the passing of an optical signal, dispersion compensation is conducted.

The controller 140 controls the switch 123 of the DCU 120 such that the level of compensation of the DCM 124 of the DCU 120 becomes the desirable level of compensation. The controller 140 may be installed externally from the dispersion compensation apparatus 100. The controller 140, for example, includes a receiving device of the dispersion compensation apparatus 100, and a network management system (NMS) included in a relay device, etc. Furthermore, the controller 140 is provided within the dispersion compensation apparatus 100 and may be used to control only the dispersion compensation apparatus 100.

In this way, the dispersion compensation apparatus 100, by control of the switch 123, enables the level of compensation conducted on an optical signal to be modified and because the switch 123 has a path latch, for example, even in the event of a power supply failure, the path of the optical signal does not change nor does the level of compensation applied to the optical signal. As such, the dispersion compensation apparatus 100 enables dispersion compensation at stable compensation levels.

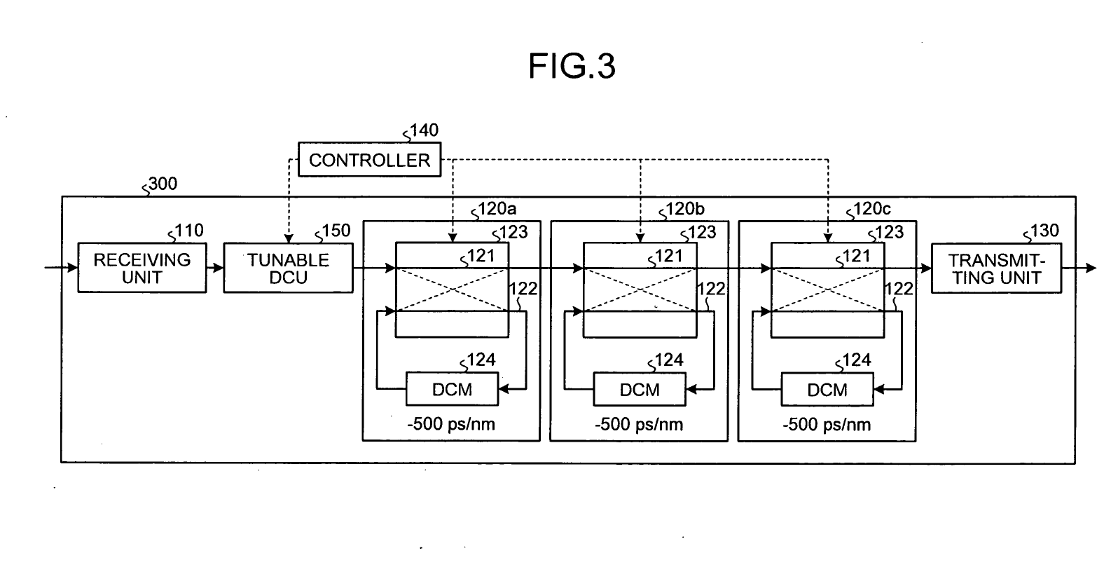

FIG. 2 is a functional diagram of a dispersion compensation apparatus according to a second embodiment of the present invention. As the apparatus includes some of the same components as the dispersion compensation apparatus 100, explanation of reference characters appearing in both FIG. 1 and FIG. 2 is herein omitted. As illustrated in FIG. 2, a dispersion compensation apparatus 200 includes a variable dispersion compensation unit (tunable DCU) 150 located between the receiving unit 110 and the DCU 120. In other words, the tunable DCU 150 is connected in series to the DCU 120.

The tunable DCU 150 conducts dispersion compensation by variable levels of compensation on the optical signal sent from the receiving unit 110. In other words, the tunable DCU 150 adds tunable levels of compensation to the fixed compensation level of the DCM 124. The tunable DCU 150, for example, can be constructed from among various variable dispersion compensation module types, such as a virtually imaged phased array. Furthermore, for example, under the control of the controller 140 externally installed, the compensation level of the tunable DCU 150 is modified.

The controller 140 controls the combination of the switch 123 conditions of the DCU 120 and the compensation level of the tunable DCU 150 such that sum of the fixed compensation level of the DCM 124 of the DCU 120 and the compensation level of the tunable DCU 150 becomes the desired compensation level.

For example, if the level of the wavelength dispersion arising in the signal is within the variable compensation range of the tunable DCU 150, by setting the switch to the bar condition, compensation by the DCM 124 is not conducted and the level of compensation of the tunable DCU 150 is set to accommodate the wavelength dispersion. Further, if the arising wavelength dispersion is beyond the range of the tunable DCU 150, by setting the switch 123 to the cross condition, compensation by the DCM 124 is conducted and the level of compensation of the tunable DCU 150 is set to accommodate the wavelength dispersion, thereby enabling the setting of a compensation level beyond the variable range of the tunable DCU 150.

In this way, the dispersion compensation apparatus 200 (by the tunable DCU 150) enables fine adjustment of the level of compensation and (by the DCM 124) enables compensation level settings that are beyond the variable range of the tunable DCU 150. As such, large quantities of DCFs and switches are not required, the quantity of required devices decreases as does the degree of signal loss due to the insertion of switches, and at the same time, dispersion compensation can be conducted for a wide range of wavelength dispersions at stable compensation levels.

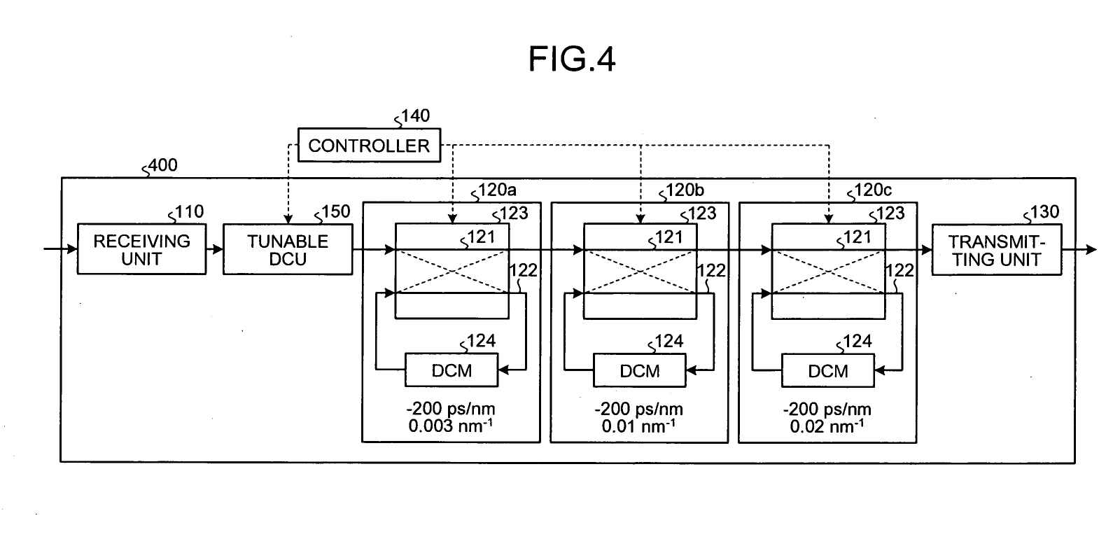

FIG. 3 is a block diagram of a dispersion compensation apparatus according to a third embodiment of the present invention. As the apparatus includes some of the same components as the dispersion compensation apparatus 200, explanation of reference characters appearing in both FIG. 2 and FIG. 3 is herein omitted. As illustrated in FIG. 3, a dispersion compensation apparatus 300 includes multiple DCUs (there are 3, a DCU 120a, a DCU 120b, and a DCU 120c). Additionally, the DCUs (120a, 120b, and 120c) are connected in series.

The DCUs (120a, 120b, and 120c) have the same structure as the DCU 120. The tunable DCU 150 operates with a compensation level range of ±500 ps/nm. Further, the compensation level of each of the DCM 124 of the DCUs (120a, 120b, and 120c) is −500 ps/nm.

The controller 140 controls the combination of the switch 123 conditions of the DCUs (120a, 120b, and 120c) and the compensation level of the tunable DCU 150 such that the sum of the fixed compensation levels of each of the DCM 124 of the DCUs (120a, 120b, and 120c) and the compensation level of the tunable DCU 150 becomes the desired compensation level.

In this way, even in the event of a dispersion level beyond the variable compensation range (500 ps/nm) of the tunable DCU 150, compensation can be conducted at a sufficient compensation level. For example, if all of the switches 123 for the DCUs (120a, 120b, and 120c) are in the bar condition, the total variable compensation range of the tunable DCU 150 and the DCM 124 is ±500 ps/nm.

Further, if only the switch 123 of the DCU 120a is in the cross condition, the total variable compensation range of the tunable DCU 150 and the DCM 124 is −1000 ps/nm to 0 ps/nm. If the switch 123 of the DCU 120b is also in the cross condition, the total variable compensation range of the tunable DCU 150 and the DCMs 124 is −1500 ps/nm to −500 ps/nm. Finally, if the switch 123 of the DCU 120c is also in the cross condition, the total variable compensation range of the tunable DCU 150 and the DCMs 124 is −2000 ps/nm to −1000 ps/nm.

In this way, the dispersion compensation apparatus 300, (by the tunable DCU 150) enables fine adjustment of the compensation level and at the same time, (by the multiple DCMs 124) enables compensation level settings that are beyond the variable range of the tunable DCU 150. As such, large quantities of DCFs and switches are not required, the quantity of required devices decreases as does the degree of signal loss due to the insertion of switches, and at the same time, dispersion compensation can be conducted for a wide range of wavelength dispersions at stable compensation levels.

While the explanation has been given in the case for the DCUs (120a, 120b, and 120c) of the DCM 124 each having a compensation level of −500 ps/nm each, these compensation levels may each be different, e.g., −500 ps/nm, −1000 ps/nm, and −1500 ps/nm, respectively, thereby enabling compensation at an even greater range.

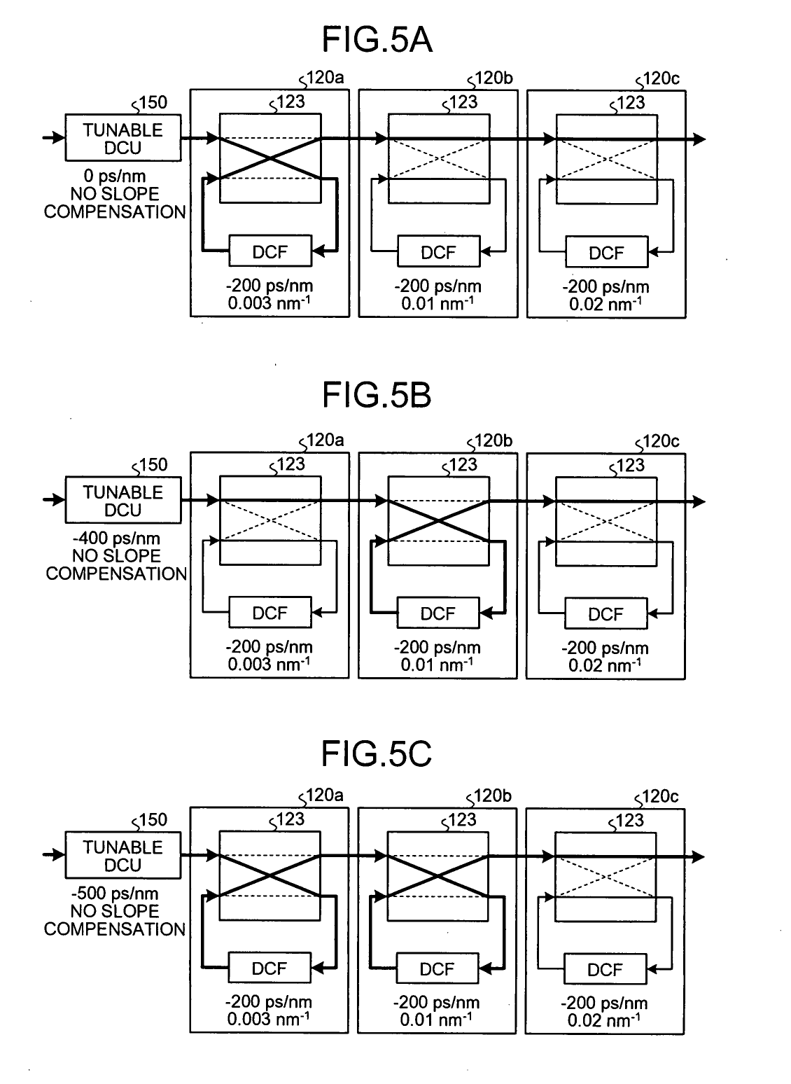

FIG. 4 is a block diagram of a dispersion compensation apparatus according to a fourth embodiment of the present invention. As the apparatus includes some of the same fundamental components as the dispersion compensation apparatus 300, explanation of reference characters appearing in both FIG. 3 and FIG. 4 is herein omitted. The each of the DCMs 124 of the DCUs (120a, 120b, and 120c) of a dispersion compensation apparatus 400 according to the fourth embodiment has a different compensation slope characteristic.

Relative dispersion slopes (RDS) of the DCMs 124 of the DCUs (120a, 120b, and 120c) are set as 0.003 nanometer⁻¹ (nm⁻¹), 0.01 nm⁻¹, and 0.02 nm⁻¹, respectively. The RDS is defined as the value of the dispersion slope/wavelength dispersion and illustrates the dispersion slope characteristics of the DCM 124. Further, the compensation level of each of the DCMs 124 for the DCUs (120a, 120b, and 120c) is set as −200 ps/nm.

The dispersion slope characteristics occurring in a transmission path differ depending on the type of the transmission path. As such, the controller 140 of the dispersion compensation apparatus 400 controls the combination of the switch 123 conditions of the DCUs (120a, 120b, and 120c); thereby enabling modification of the dispersion slope characteristics of an optical signal.

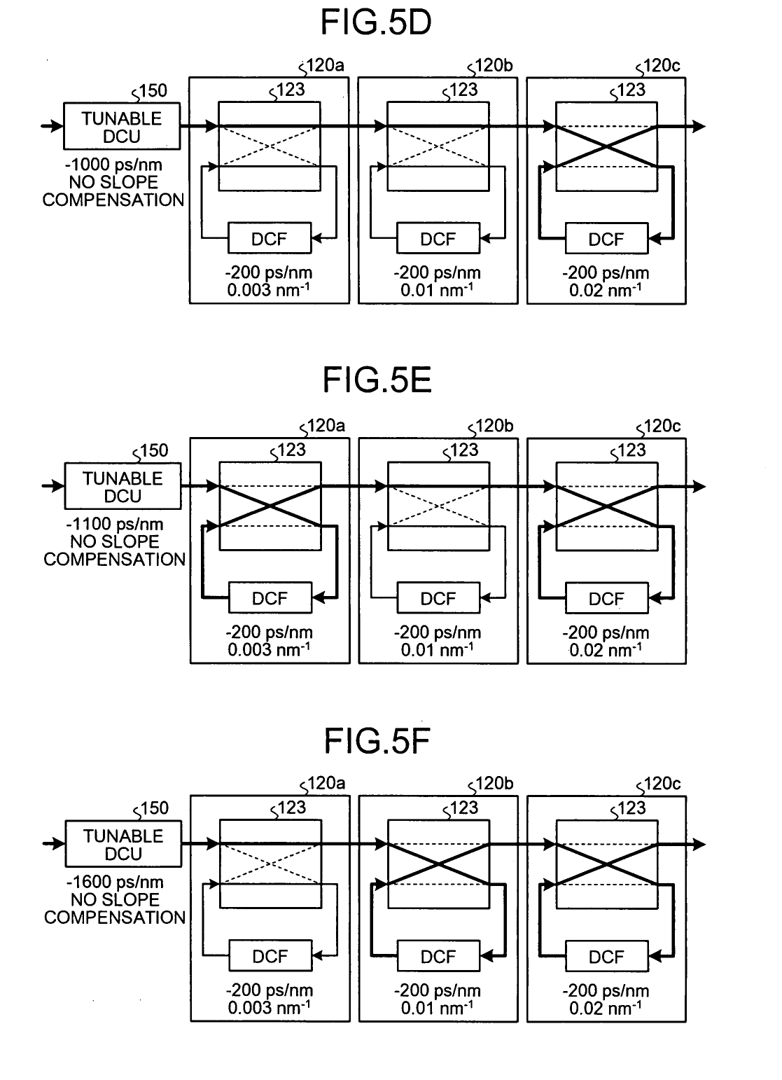

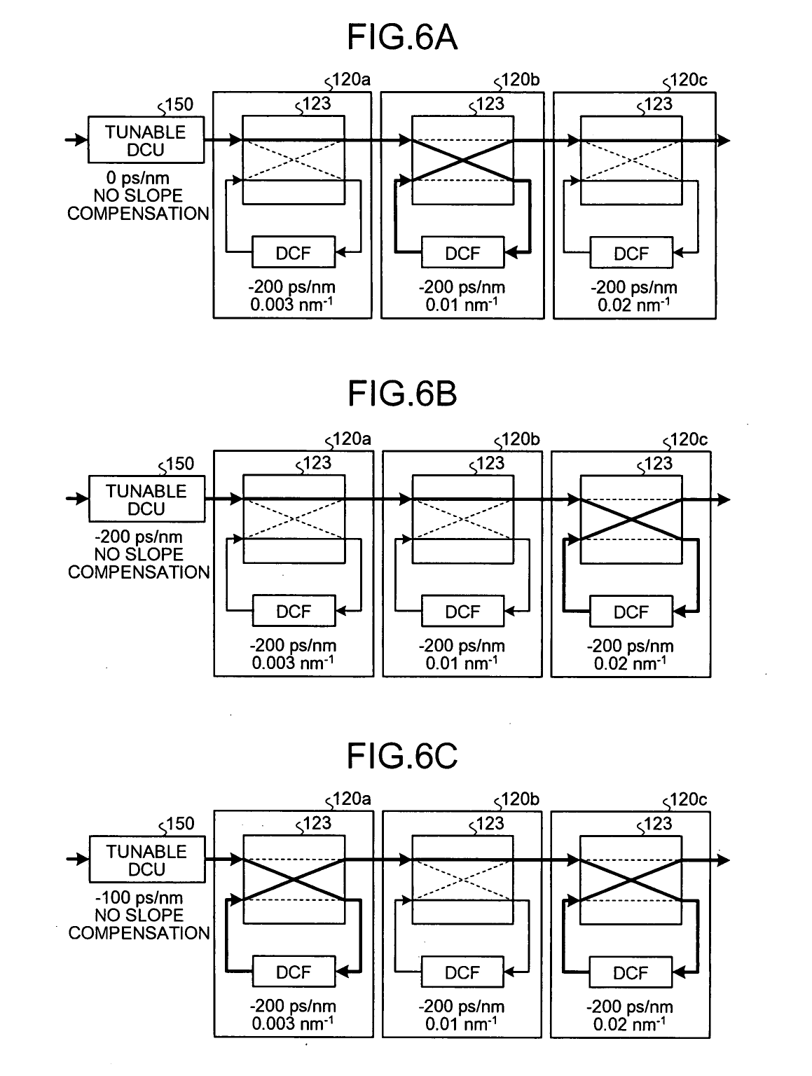

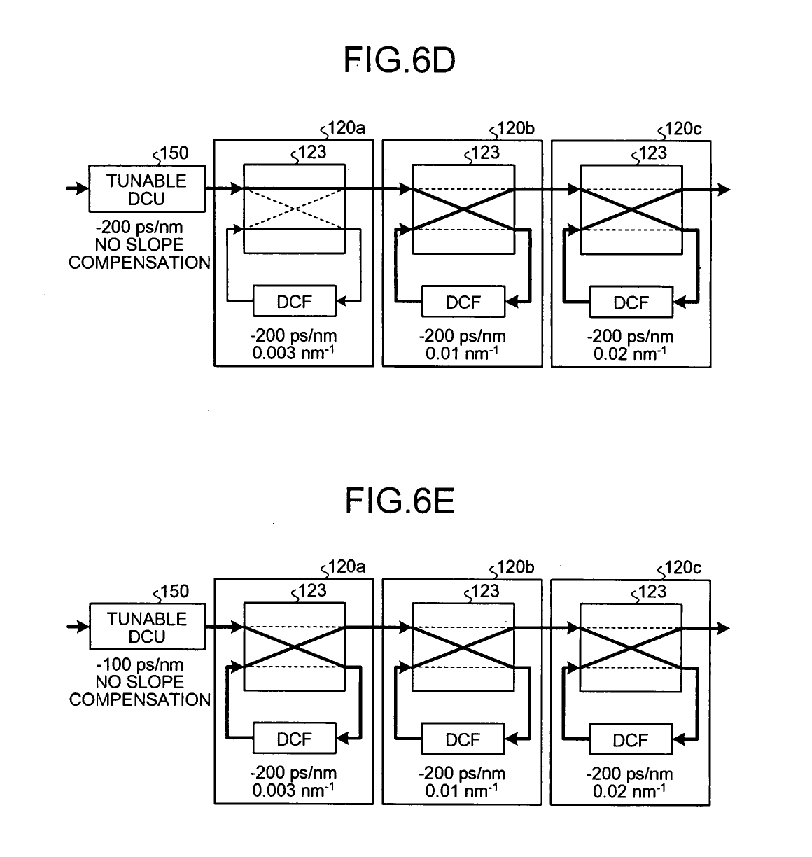

FIG. 5A to FIG. 5F, FIG. 6A to FIG. 6E, FIG. 7A, and FIG. 7B are block diagrams illustrating examples of switch settings for the switch 123 of the dispersion compensation apparatus 400. Here, the receiving unit 110, the transmitting unit 130, and the controller 140 have been omitted. Furthermore, reference characters of components not herein described have also been omitted.

As examples of transmission path types, single mode fiber (SMF), true wave reduced slope (TW-RS), and enhanced large effective area fiber (ELEAF) are herein described.

Here, for SMF, a wavelength dispersion of 16.8 ps/nm/km and a dispersion slope of 0.057 ps/nm/km/nm are assumed. For TW-RS, a wavelength dispersion of 4.2 ps/nm/km and a dispersion slope of 0.045 ps/nm/km/nm are assumed. For ELEAF, a wavelength dispersion of 3.9 ps/nm/km and a dispersion slope of 0.083 ps/nm/km/nm are assumed.

The tunable DCU 150 is assumed to be able to conduct compensation at a compensation level range of ±1600 ps/nm. Furthermore, slope compensation is not carried out by the tunable DCU 150.

FIG. 5A illustrates a setting example for a −200 ps/nm wavelength dispersion occurring in an SMF transmission path.

In this case, the compensation level of the tunable DCU 150 is set as 0 ps/nm. Also, by the cross condition of only the switch 123 of the DCU 120a, compensation is conducted on the optical signal at a compensation level of −200 ps/nm, and corresponding to appropriate dispersion slope characteristics, slope compensation can be conducted.

FIG. 5B illustrates a setting example for a −600 ps/nm wavelength dispersion occurring in an SMF transmission path. In this case, the compensation level of the tunable DCU 150 is set as −400 ps/nm and along with the cross condition of the switch 123 of the DCU 120b, compensation is conducted on the optical signal at a compensation level of −200 ps/nm, and corresponding to appropriate dispersion slope characteristics, slope compensation can be conducted.

FIG. 5C illustrates a setting example for a −900 ps/nm wavelength dispersion occurring in an SMF transmission path. In this case, the compensation level of the tunable DCU 150 is set as −500 ps/nm and along with the cross condition of the switches 123 of the DCU 120a and the DCU 120b, compensation is conducted on the optical signal at a compensation level of −900 ps/nm, and corresponding to appropriate dispersion slope characteristics, slope compensation can be conducted.

FIG. 5D illustrates a setting example for a −1200 ps/nm wavelength dispersion occurring in an SMF transmission path. In this case, the compensation level of the tunable DCU 150 is set as −1000 ps/nm and along with the cross condition of only the switch 123 of the DCU 120c, compensation is conducted on the optical signal at a compensation level of −1200 ps/nm, and corresponding to appropriate dispersion slope characteristics, slope compensation can be conducted.

FIG. 5E illustrates a setting example for a −1500 ps/nm wavelength dispersion occurring in an SMF transmission path. In this case, the compensation level of the tunable DCU 150 is set as −1100 ps/nm and along with the cross condition of the switches 123 of the DCU 120a and the DCU 120c, compensation is conducted on the optical signal at a compensation level of −1500 ps/nm, and corresponding to appropriate dispersion slope characteristics, slope compensation can be conducted.

FIG. 5F illustrates a setting example for a −2000 ps/nm wavelength dispersion occurring in an SMF transmission path. In this case, the compensation level of the tunable DCU 150 is set as −1600 ps/nm and along with the cross condition of the switches 123 of the DCU 120b and the DCU 120c, compensation is conducted on the optical signal at a compensation level of −2000 ps/nm, and corresponding to appropriate dispersion slope characteristics, slope compensation can be conducted.

FIG. 6A illustrates a setting example for a −200 ps/nm wavelength dispersion occurring in a TW-RS transmission path. In this case, the compensation level of the tunable DCU 150 is set as 0 ps/nm and along with the cross condition of only the switch 123 of the DCU 120b, compensation is conducted on the optical signal at a compensation level of −200 ps/nm, and corresponding to appropriate dispersion slope characteristics, slope compensation can be conducted.

FIG. 6B illustrates a setting example for a −400 ps/nm wavelength dispersion occurring in a TW-RS transmission path. In this case, the compensation level of the tunable DCU 150 is set as −200 ps/nm and along with the cross condition of only the switch 123 of the DCU 120c, compensation is conducted on the optical signal at a compensation level of −400 ps/nm, and corresponding to appropriate dispersion slope characteristics, slope compensation can be conducted.

FIG. 6C illustrates a setting example for a −500 ps/nm wavelength dispersion occurring in a TW-RS transmission path. In this case, the compensation level of the tunable DCU 150 is set as −100 ps/nm and along with the cross condition of the switches 123 of the DCU 120a and the DCU 120c, compensation is conducted on the optical signal at a compensation level of −500 ps/nm, and corresponding to appropriate dispersion slope characteristics, slope compensation can be conducted.

FIG. 6D illustrates a setting example for a −600 ps/nm wavelength dispersion occurring in a TW-RS transmission path. In this case, the compensation level of the tunable DCU 150 is set as −200 ps/nm and along with the cross condition of the switches 123 of the DCU 120b and the DCU 120c, compensation is conducted on the optical signal at a compensation level of −600 ps/nm, and corresponding to appropriate dispersion slope characteristics, slope compensation can be conducted.

FIG. 6E illustrates a setting example for a −700 ps/nm wavelength dispersion occurring in a TW-RS transmission path. In this case, the compensation level of the tunable DCU 150 is set as −100 ps/nm and along with the cross condition of all of the switches 123 for the DCU 120a, the DCU 120b and the DCU 120c, compensation is conducted on the optical signal at a compensation level of −700 ps/nm, and corresponding to appropriate dispersion slope characteristics, slope compensation can be conducted.

FIG. 7A illustrates a setting example for a −200 ps/nm wavelength dispersion occurring in an ELEAF transmission path. In this case, the compensation level of the tunable DCU 150 is set as 0 ps/nm and along with the cross condition of only the switch 123 of the DCU 120c, compensation is conducted on the optical signal at a compensation level of −200 ps/nm, and corresponding to appropriate dispersion slope characteristics, slope compensation can be conducted.

FIG. 7B illustrates a setting example for a −300 ps/nm wavelength dispersion occurring in an ELEAF transmission path. In this case, the compensation level of the tunable DCU 150 is set as +100 ps/nm and along with the cross condition of the switch 123 of the DCU 120b and the DCU 120c, compensation is conducted on the optical signal at a compensation level of −300 ps/nm, and corresponding to appropriate dispersion slope characteristics, slope compensation can be conducted.

In this way, even for varying types of transmission paths, the dispersion compensation apparatus 400 enables modification of the combination of the DCMs 124 (the DCM 124 each having different dispersion slope characteristics) by controlling the combination of the switch 123 conditions of the DCUs (120a, 120b, and 120c), and corresponding to appropriate dispersion slope characteristics, enables slope compensation.

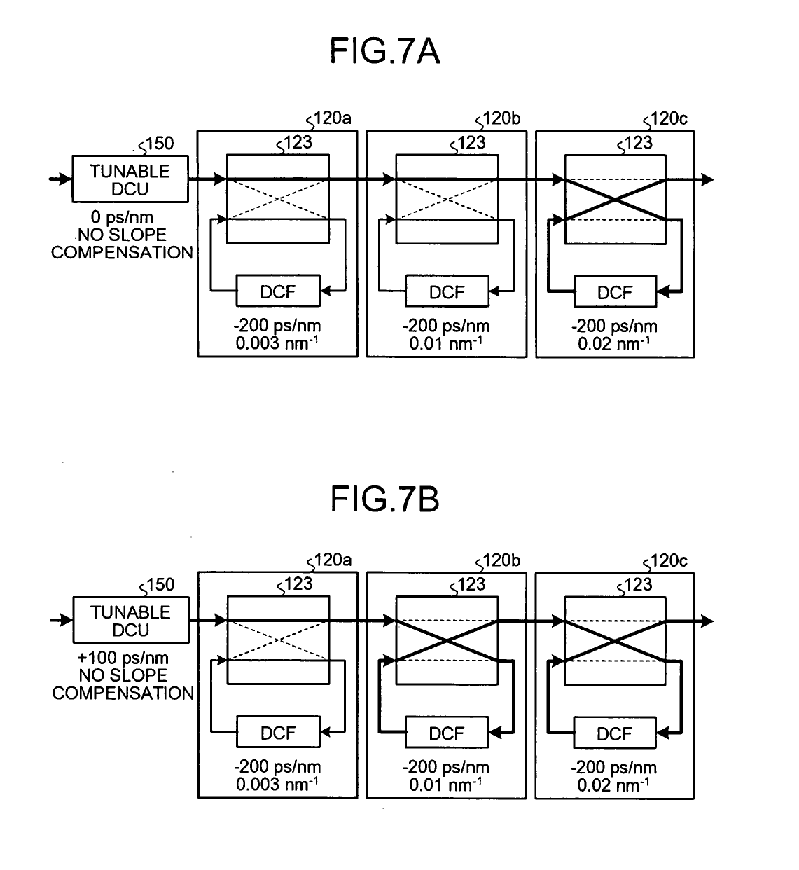

FIG. 8 is a block diagram of an application example for a dispersion compensation apparatus according to the present invention applied in a communication system. Here, the communication system is a multiplex communication system that multiplexes signals and simultaneously transmits and receives. As illustrated in FIG. 8, a communication system 800 includes a transmitter (TX) 810, a multiplexer (MUX) 820, a dispersion compensator 830, an amplifier 840, a demultiplexer (DEMUX) 850, and a receiver (RX) 860; all connected in series through a transmission path.

The TX 810 sends an optical signal to the MUX 820. Additionally, there are multiple TXs 810. The MUX 820 multiplexes each of the optical signals sent from the TXs 810 and sends the multiplexed signal to the dispersion compensator 830. The MUX 820 may be integrated, such as with the TX 810 and/or the dispersion compensator 830.

Here, the dispersion compensator 830 is the dispersion compensation apparatus 100 according to the first embodiment. Alternatively, it may also be any one of the other dispersion compensation apparatuses according to any of the other embodiments. The dispersion compensator 830 conducts dispersion compensation on the signal sent from the MUX 820 to send to the next dispersion compensator 830 or to the DEMUX 850.

Three dispersion compensators 830 are provided at each point of the communication system 800. At each point, each dispersion compensator 830 conducts compensation at an optimal level. Furthermore, the controller 140 is integrated into each of the dispersion compensation apparatuses 100. Also, the dispersion compensator 830 may be applied merely as a relay device for the communication system 800 and/or as a receiver.

The amplifier 840, appropriately provided in the transmission path, amplifies the attenuated optical signal. Further, the amplifier 840 may be integrated with the TX 810, the MUX 820, the dispersion compensator 830, the DEMUX 850, or the RX 860.

The DEMUX 850 demultiplexes the optical signal received from the dispersion compensator 830 and sends each of the demultiplexed optical signals to the RXs 860. The DEMUX 850 may be integrated with the dispersion compensator 830, the RX 860, etc. The RXs 860 receive the optical signal sent from the DEMUX 850.

The dispersion compensator 830 includes a controller interface (controller I/F) 831. Within the communication system 800, not shown in the figure, is a control center. The control center sends dispersion compensator setting information to the controller 140 through the controller I/F 831 of each of the dispersion compensator 830.

The dispersion compensator setting information, for example, is information indicating whether the switch 123 of the DCU 120 is in a cross condition or a bar condition. It may also be information indicating the combination of the switch 123 conditions and the compensation level of the tunable DCU 150. Furthermore, the information may be information indicating the compensation level setting required for a target dispersion compensator 830, or may include information related to dispersion slope characteristics.

The controller 140 of the dispersion compensator 830, based on the dispersion compensator setting information sent from the control center, controls the compensation level of the tunable DCU 150 and the switches 123 of the DCU 120. The controller I/F 831 is formed by a DCM card, etc. included in the DCU 120. Furthermore, the controller 140 is formed by a central processing unit connected to the DCM card, etc.

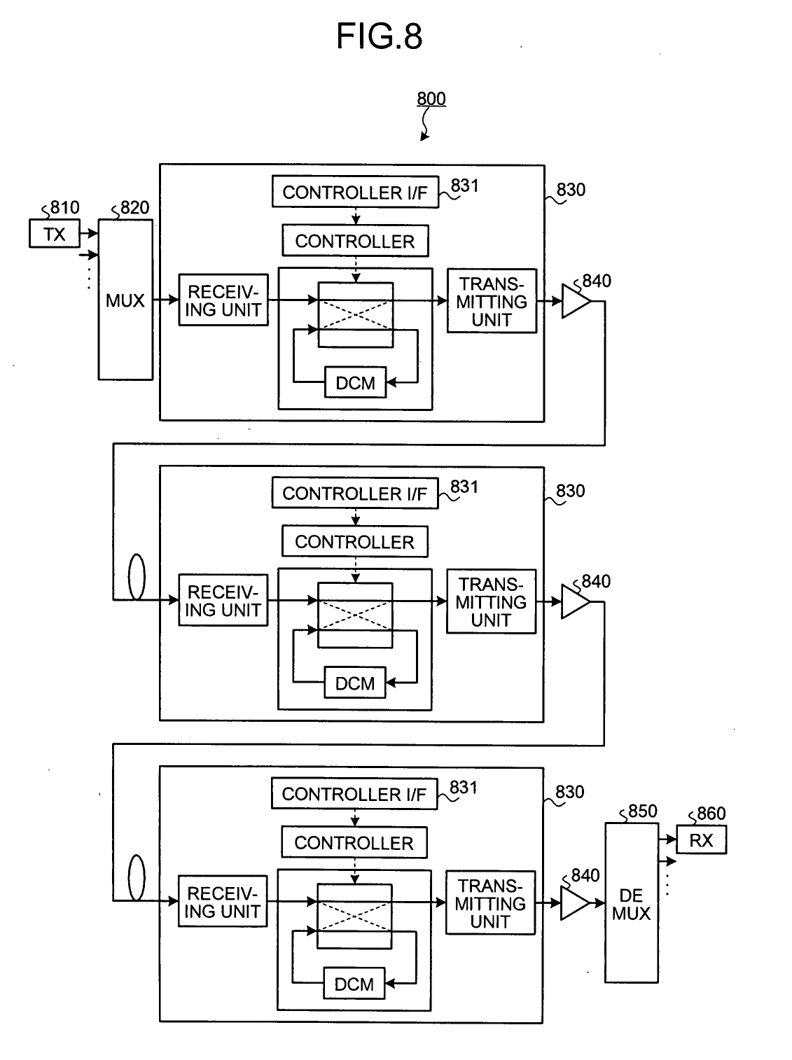

FIG. 9 is a block diagram of another application example for a dispersion compensation apparatus according to the embodiments of the present invention applied in a communication system. As illustrated in FIG. 9, in a communication system 900, a network is formed by a linked connection of multiple nodes 901 to 905. Further, a NMS 906 connected through a local area network to the node 905 manages network operations.

The nodes 901 to 905 have a function of a dispersion compensation apparatus according to any of the embodiments (in this example, the dispersion compensation apparatus 100). The NMS 906 sends dispersion compensator setting information for the nodes 901 to 905 through the network.

As described above, a switch secures the path of an optical signal by a latch, thereby enabling a compensation level for an optical signal to remain unchanged, for example, even in the event of a power failure the path of the optical signal will not change. As such, the dispersion compensation apparatus and dispersion compensation method according to the present invention enable compensation at a stable level to be conducted.

Furthermore, the dispersion compensation apparatus and dispersion compensation method enable fine compensation adjustment via a tunable DCU. Hence, the number of required devices and signal loss due to the insertion of switches are reduced. In addition, the setting of a compensation level greater than the variable range of the tunable DCU is possible. Therefore, with a reduced number of required devices and less signal loss due to the insertion of switches, compensation of a wide range of wavelength dispersions can be sufficiently conducted.

The dispersion compensation apparatus and dispersion compensation method according to the present invention also include multiple DCUs and depending on their combination of use, an even greater range of wavelength dispersions can be sufficiently compensated. In addition, the dispersion slopes of the DCM of the DCU vary and by combining them, dispersion slope compensation can be appropriately conducted for various types of transmission paths.

The switch 123 of the DCU 120 described in the embodiments is a switch having a crossbar configuration. However, the switch 123 is not limited to this structure. For example, the switch 123 may also have the structure of a 1×n switch, an n×n switch, etc.

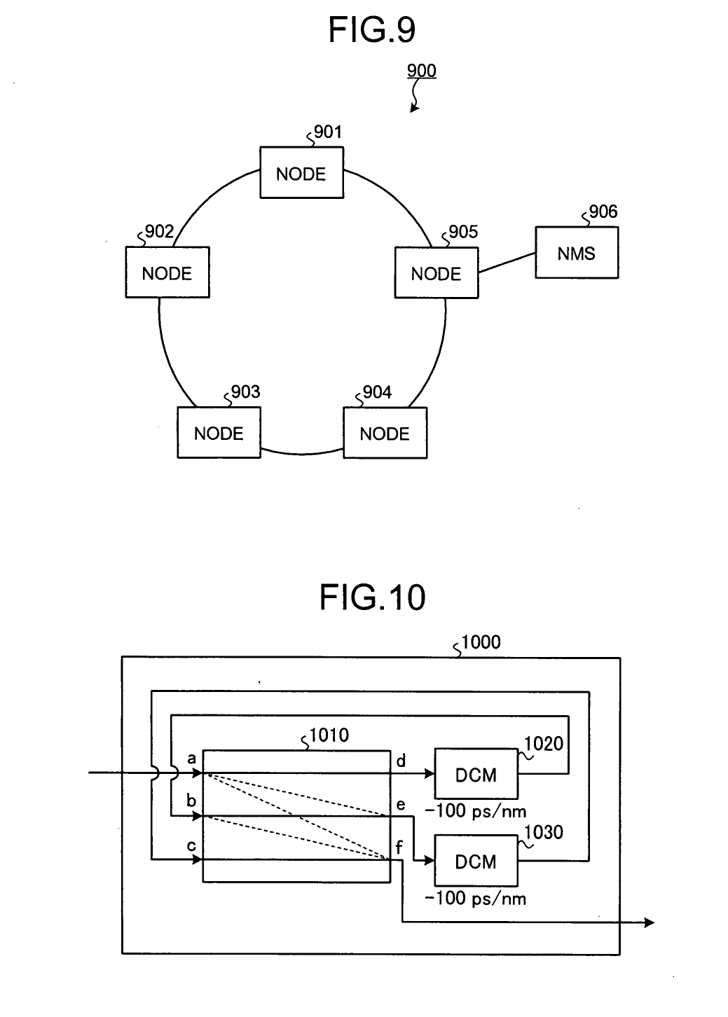

FIG. 10 is a block diagram of a 3×3 switch application in a DCU. A DCU 1000 includes a 3×3 switch 1010, a first DCM 1020, and a second DCM 1030. The 3×3 switch 1010 includes a first RXa, a second RXb, a third RXc, a first TXd, a second TXe, and a third TXf. Here, the compensation level for both the first DCM first DCM and the second DCM 1030 is −100 ps/nm.

The optical signal sent from the receiving unit 110 (refer to FIG. 1) is received by the first RXa and is sent from the first TXd, the second TXe, or the third TXf. An optical signal sent from the first TXd is compensated by the first DCM first DCM 1020 at a compensation level of −100 ps/nm and is sent to the second RXb.

An optical signal sent from the second TXe is compensated by the second DCM 1030 at a compensation level of −100 ps/nm and is sent to the third RXc. An optical signal sent from the third TXf is sent to the transmitting unit 130 (refer to FIG. 1). An optical signal received by the second RXb is consequently sent from either the second TXe or the third TXf. An optical signal received by the third RXc is consequently sent from the third TXf.

For example, in the case where the first RXa and the first TXd are connected by the 3×3 switch 1010, and the second RXb and the third TXf are connected by the 3×3 switch 1010, an optical signal is sent to the transmitting unit 130 passing through the first RXa, the first TXd, the first DCM 1020, the second RXb, and the third TXf; and in route is compensated by the first DCM 1020 at a compensation level of −100 ps/nm.

Further, in the case where the first RXa and the first TXd are connected by the 3×3 switch 1010, the second RXb and the second TXe are connected by the 3×3 switch 1010, and the third RXc and the third TXf are connected by the 3×3 switch 1010, an optical signal is sent to the transmitting unit 130 passing through the first RXa, the first TXd, the first DCM 1020, the second RXb, the second TXe, the second DCM 1030, the third RXc and the third TXf; and in route is compensated by the first DCM 1020 and the second DCM 1030 at a total compensation level of −200 ps/nm.

In this way, application of an n×n switch in the DCU 120 enables a variety of compensation levels within the DCU 120.

According to the embodiments described above, dispersion compensation can be conducted for a wide range of wavelength dispersion levels by stable levels of dispersion compensation.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A dispersion compensation apparatus comprising a dispersion compensation unit that conducts dispersion compensation on an optical signal sent from a transmitting device through a transmission path, and that includes
a switch that switches a path of the optical signal between a first path and a second path, and that latches to one of the first path and the second path to which the path is switched; and
a fixed dispersion compensation unit that is provided on the second path, and that conducts dispersion compensation at a fixed level upon an optical signal passing through the second path.

2. The dispersion compensation apparatus according to claim 1, further comprising a variable dispersion compensation unit that conducts dispersion compensation on the optical signal at a variable level and is connected in series to the dispersion compensation unit.

3. The dispersion compensation apparatus according to claim 1, wherein the switch is a crossbar switch, and switches the path by switching the switch between a bar condition and a cross condition.

4. The dispersion compensation apparatus according to claim 3, wherein
the switch includes a first receiver, a second receiver, a first transmitter, and a second transmitter,
the first path is formed by a path from the first receiver to the first transmitter without including either of the second transmitter or the second receiver in the path; and
the second path is formed by a path from the first receiver to the first transmitter through the second transmitter and the second receiver.

5. The dispersion compensation apparatus according to claim 1, the dispersion compensation unit is provided in plurality, and is connected in series to each other.

6. The dispersion compensation apparatus according to claim 5, wherein
the respective dispersion compensation units include the fixed dispersion compensation unit, and
the fixed dispersion compensation units of the respective dispersion compensation units conduct dispersion compensation at different fixed levels from each other.

7. The dispersion compensation apparatus according to claim 5, wherein
the respective dispersion compensation units include the fixed dispersion compensation unit, and
the fixed dispersion compensation units of the respective dispersion compensation units have different dispersion slopes from each other.

8. The dispersion compensation apparatus according to claim 2, further comprising a control unit that controls combination of the switch and the variable level of the variable dispersion compensation unit such that a sum of the fixed level of the fixed dispersion compensation unit and the variable level of the variable dispersion compensation unit becomes a desired dispersion level.

9. The dispersion compensation apparatus according to claim 5, further comprising a control unit that controls combination of the switch in the respective dispersion compensation units and the variable level of the variable dispersion compensation unit such that a sum of the fixed level of the dispersion compensation units and the variable level of the variable dispersion compensation unit becomes a desired dispersion level.

10. The dispersion compensation apparatus according to claim 9, wherein the control unit controls the combination so that a desired dispersion slope according to a type of the transmission path.

11. The dispersion compensation apparatus according to claim 8, wherein the control unit is formed by a network management system.

12. A dispersion compensation method of conducting dispersion compensation on an optical signal sent from a transmitting device through a transmission path, the dispersion compensation method comprising:
switching, based on a desired compensation level, a path of the optical signal between a first path and a second path for the optical signal;
latching to one of the first path and the second path to which the path is switched; and
conducting dispersion compensation at a fixed level on an optical signal passing through the second path when the path is switched to the second path at the switching.

13. The dispersion compensation method according to claim 12, further comprising conducting variable dispersion compensation on the optical signal, the variable dispersion compensation in which a variable level is added to the fixed level.
